(19) United States
(12) Patent Application Publication
(10) Pub. No.: US 2003/0062763 A1
(43) Pub. Date: Apr. 3, 2003

(54) Spoke for a tensioned spoked wheel assembly

(76) Inventor: Rolf Dietrich, Toledo, OH (US)

Correspondence Address: PURDUE LAW OFFICES, 2735 N. HOLLAND-SYLVANIA ROAD, SUITE B-2, TOLDEO, OH, 43615

(21) Appl. No.: 10/262,315

(22) Filed: Sep. 30, 2002

Related U.S. Application Data
(60) Provisional application No. 60/325,827, filed on Sep. 28, 2001.

(51) Int. Cl. B60B 1/00

(52) U.S. Cl. 301/104

(57) ABSTRACT

A spoke for a tensioned spoke wheel is disclosed. The spoke comprises a shaft having first and second ends. A first segment of the shaft, adjacent the first end, has a given cross-sectional area, while a second segment of the shaft has a cross-sectional area less than the given area. The second segment is adjacent, and toward the second end from, the first. The surface of a part of the unthreaded portion of the first segment is shaped to form at least two opposed, flat, torque transmitting surfaces.

### CROSS-REFERENCE TO RELATED APPLICATION

The benefit of the filing date of Provisional Application No. 60/325,827, Filed Sep. 28, 2001 is claimed.

### STATEMENT CONCERNING FEDERALLY SPONSORED RESEARCH OR DEVELOPMENT

Not applicable

### REFERENCE TO A “SEQUENCE LISTING”

Not applicable

### BACKGROUND OF THE INVENTION

(1) Field of the Invention

The present invention relates generally to wheels for human powered vehicles such as bicycles, wheel chairs and the like, and especially to a novel spoke therefor.

(2) Description of Related Art Including Information Disclosed Under 37 CFR 1.97 and 37 CFR 1.98

Spokes for wheels for human powered vehicles have been the subjects of numerous innovations over the years.

Known are spokes that have a first given diameter over a major length of the spoke and a first end including an externally threaded portion with a second, given diameter which is larger than the first diameter. Typically, the other, second end of the spoke also has the second given diameter, and terminates in a head. Such graduated spokes, known as double butted spokes, have reduced wind resistance and improved aerodynamic properties by comparison with spokes that have the second given diameter over their entire length. Double butted spokes, however, are not well suited for use in wheels where the spokes are under a high tension. When a spoke nipple or spoke nut is turned on the threaded end of the spoke until the tension in the spoke gets to be quite high, the spoke end will sometimes turn with the nipple or nut, preventing a desired change in the spoke tension. In other words, the threaded end of the spoke turns with the nipple whereas it is necessary to rotate the nipple, relative to the threaded end of the spoke, in order to change the tension in the spoke. This problem arises also, in high tension applications, in the case of spokes that have a minimal, constant diameter.

U.S. Pat. No. 6,431,035, Aug. 13, 2002, recognizes the problem that a spoke end will turn with the nipple, and suggests a tool which can be used to grip a spoke so that the spoke end can be prevented from turning with the nipple, thus enabling adjustment.

The website of DT Swiss AG, CH-2500 Biel, Switzerland, discloses a “DT New Aero” Spoke with a flattened central portion which has a minimum thickness of 1.0 mm and a maximum thickness of 2.0 mm.

### BRIEF SUMMARY OF THE INVENTION

The present invention is an improved spoke for a tensioned spoke wheel. The spoke comprises a shaft having first and second ends. A first segment of the shaft, adjacent the first end, has a given cross-sectional area and is threaded, while a second segment of the shaft has a cross-sectional area less than the given area. The second segment is adjacent, and toward the second end from, the first. The surface of a part of the unthreaded portion of the first segment is shaped to form at least two opposed, flat, torque transmitting surfaces. The flat, torque transmitting surfaces can be formed by squeezing a portion of the spoke near the threads to produce two opposed flat surfaces on the side of the spoke. In the case of a double butted spoke, such flats are preferably formed within the larger diameter end region of the spoke. When it is desired to adjust the tension on such a spoke, the flats are easily engaged by a tool, which can be held to prevent the end of the spoke from rotating when the nipple or nut is turned, thereby facilitating the desired change in spoke tension. It is usually preferred that, except for the flats thereon, the spokes of the invention be circular in cross section.

Accordingly, it is an object of the present invention to provide an improved spoke, especially a butted spoke.

It is a further object of the invention to provide a simple method for producing an improved spoke.

It is a further object of the present invention to provide a graduated spoke which is especially suited for high tension applications in spoked wheels, especially for human powered vehicles.

These and other objects and advantages of spokes according to the present invention will be fully appreciated by those skilled in the art upon reviewing the disclosures herein.

### BRIEF DESCRIPTION OF THE SEVERAL VIEWS OF THE DRAWING

FIG. 1 is a side view of a spoke according to present invention.

FIG. 2 is a front view of the spoke shown in FIG. 1.

### DETAILED DESCRIPTION OF THE PREFERRED EMBODIMENTS

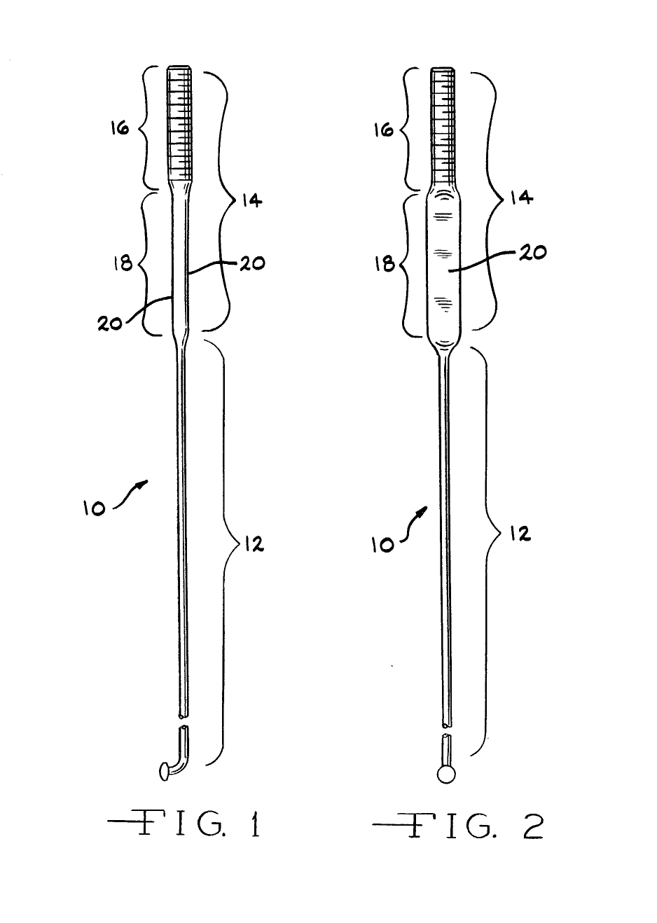

Referring to FIGS. 1 and 2, a graduated, double butted spoke is indicated generally at 10. The spoke comprises a central region 12 and an end region 14. A known, graduated spoke has a 17 gauge central region and a 14 gauge end region. Such a spoke was modified, according to the present invention, to produce the spoke 10. The central region 12 of the spoke 10 is 17 gauge and has a nominal diameter of approximately 58 thousandths of an inch. The end region 14 of the spoke 10 is 14 gauge and has a nominal diameter of approximately 80 thousandths of an inch. A portion 16 of the end portion 14 is threaded.

According to the present invention, an unthreaded portion 18 of the end region 14 has been modified to produce two torque transmitting surfaces comprising flat surfaces 20. The modification was achieved by positioning the portion 18, and an adjacent portion of the central region 12, between the jaws of a vise, and closing the jaws to deform the portion 18. Once the jaws closed to the point where they engaged the central portion 12, the force required to close the jaws of the vice further became much greater and no further force was applied to the jaws. When the spoke was released from the vise, the flats 20 were completely formed. The flats 20 were about 65 thousandths of an inch apart. In other words, the flats were separated by a distance, which was a few thousandths of an inch greater than the diameter of the central region 12 of the spoke 10, and perhaps 15 thousandths of an inch less than the diameter of the spoke portion 18. In a wheel (not shown), this narrowed portion 18 of the spoke 10 will present a smaller profile as it rotates with the wheel, thereby enhancing the aerodynamics of the wheel.

The torque transmitting surfaces, i.e., the flats 20, are easily gripped by pliers and most other gripping tools, so that one can easily engage the spoke flats, and prevent the end of the spoke 10 from turning while a nipple or nut is turned on the threaded portion 16 of the spoke, even when the tension in the spoke 10 is high.

It is preferred that the threads on a spoke according to the invention be formed by rolling, so that the major diameter of the threaded portion of the spoke is greater than the diameter of the segment of the spoke which is threaded.

It will be appreciated that a spoke according to the invention may well have torque transmitting surfaces other than two opposed flat surfaces. For example, the spoke may have four flat torque transmitting surfaces, or more. In the case of a spoke with four torque transmitting surfaces, such surfaces would generally form an angle of ninety degrees with an adjacent torque transmitting surface.

1. A spoke for a tensioned spoke wheel, said spoke comprising
a shaft having first and second ends, a first segment of said shaft adjacent the first end having a given cross-sectional area, and a second segment of said shaft adjacent, and toward the second end from, said first shaft segment having a cross-sectional area less than the given area, said first segment having a threaded portion and an unthreaded portion which is adjacent to said threaded portion and is between said threaded portion and said second end,
wherein the surface of a part of said unthreaded portion of said first segment is shaped to form at least two opposed, flat, torque transmitting surfaces.

2. A method for producing a spoke comprising a shaft having first and second ends, said first end including a threaded portion and an unthreaded portion adjacent to said threaded portion, wherein said unthreaded portion includes at least two torque transmitting surfaces consisting of opposed flat surfaces, said method comprising the steps of
engaging the unthreaded portion of the spoke between two spaced, generally parallel tool surfaces,
advancing the spaced surfaces, one towards the other, until they engage the unthreaded portion of the spoke, and beyond, so that the surfaces permanently and inelastically deform the unthreaded portion to produce the two torque transmitting surfaces, and
releasing the spoke from the tool surfaces.

3. A spoke for a tensioned spoke wheel as claimed in claim 1 which, except for said flat, torque transmitting surfaces, is generally circular in cross section.

4. A spoke for a tensioned spoke wheel as claimed in claim 1 which additionally has a third segment which is between said second segment and the second end of the spoke, wherein said third segment has a cross-sectional area greater than that of said second segment.

5. A spoke for a tensioned spoke wheel as claimed in claim 4 which, except for said flat, torque transmitting surfaces, is generally circular in cross section.

6. A spoke for a tensioned spoke wheel as claimed in claim 3 wherein the major diameter of the threaded portion of said first segment is greater than the diameter of said first segment of the spoke.

7. A spoke for a tensioned spoke wheel as claimed in claim 5 wherein the major diameter of the threaded portion of said first segment is greater than the diameter of said first segment of the spoke.
